(19) United States
(12) Patent Application Publication
(10) Pub. No.: US 2015/0264048 A1
(43) Pub. Date: Sep. 17, 2015

(54) INFORMATION PROCESSING APPARATUS, INFORMATION PROCESSING METHOD, AND RECORDING MEDIUM

(71) Applicant: SONY CORPORATION, Tokyo (JP)

(72) Inventors: TAIZO SHIRAI, KANAGAWA (JP); KOICHI SAKUMOTO, TOKYO (JP); TOYOHIDE ISSHI, KANAGAWA (JP); KUNIHITO SAWAI, KANAGAWA (JP); YUJI IDE, KANAGAWA (JP)

(21) Appl. No.: 14/637,736

(22) Filed: Mar. 4, 2015

(30) Foreign Application Priority Data
Mar. 14, 2014 (JP) 2014-052005

(51) Int. Cl. H04L 29/06

(52) U.S. Cl. CPC H04L 63/0876; H04L 63/083

(57) ABSTRACT

There is provided an information processing apparatus including an authentication process unit configured to obtain an authentication request from another apparatus, and perform an authentication process between the information processing apparatus and the another apparatus in response to the authentication request, and a notification generation unit configured to, when the authentication process unit performs the authentication process between the information processing apparatus and the another apparatus, generate information for notifying a result of the authentication process and information for limiting use of the another apparatus.

### CROSS REFERENCE TO RELATED APPLICATIONS

This application claims the benefit of Japanese Priority Patent Application JP2014-052005 filed Mar. 14, 2014, the entire contents of which are incorporated herein by reference.

### BACKGROUND

The present disclosure relates to information processing apparatuses, information processing methods, and recording media.

The methods of authenticating individuals fall into three categories: knowledge-based authentication; possession-based authentication; and biometric authentication. Examples of knowledge-based authentication include authentication based on a password. Examples of possession-based authentication include authentication using a magnetic card with a magnetic stripe or an IC card with an IC chip. Examples of biometric authentication include authentication based on a fingerprint, authentication based on veins, and authentication based on an iris.

In the case of possession-based authentication, the authentication may be performed by a key device containing key information communicating with another device which is external to the key device and for which the user of the key device is to be authenticated (such a device is hereinafter referred to as an “authenticating device”). For example, JP 2005-127050A describes a smart entry system in which a vehicle sends a call signal to a key device, the key device returns a response signal containing unique ID information in response to the call signal, and the vehicle checks the response signal to unlock the door.

### SUMMARY

If, for example, a key device containing key information includes a radio communication system which has a maximum communication range of several tens of meters, then when an authentication process is automatically performed in response to an authentication request which is sent from an authenticating device based on a user's operation performed on the authenticating device, the authentication process is completed without the need of the user's operation performed on the key device, which is convenient for the user. However, if the authentication process is automatically performed in response to an authentication request which is sent from the authenticating device based on a third party's operation performed on the authenticating device, the authenticating device is unfortunately used by the third party.

Therefore, the present disclosure proposes a novel and improved information processing apparatus, information processing method, and recording medium which can remotely limit an operation performed on an authenticating device, after an authentication process has been performed on the authenticating device in response to an authentication request from the authenticating device.

According to an embodiment of the present disclosure, there is provided an information processing apparatus including an authentication process unit configured to obtain an authentication request from another apparatus, and perform an authentication process between the information processing apparatus and the another apparatus in response to the authentication request, and a notification generation unit configured to, when the authentication process unit performs the authentication process between the information processing apparatus and the another apparatus, generate information for notifying a result of the authentication process and information for limiting use of the another apparatus.

According to another embodiment of the present disclosure, there is provided an information processing method including obtaining an authentication request from another apparatus, and performing an authentication process between an information processing apparatus and the another apparatus in response to the authentication request, and generating, when the authentication process is performed between the information processing apparatus and the another apparatus, information for notifying a result of the authentication process and information for limiting use of the another apparatus.

According to another embodiment of the present disclosure, there is provided a non-transitory computer-readable recording medium having a program recorded thereon, the program causing a computer to execute obtaining an authentication request from another apparatus, and performing an authentication process between an information processing apparatus and the another apparatus in response to the authentication request, and generating, when the authentication process is performed between the information processing apparatus and the another apparatus, information for notifying a result of the authentication process and information for limiting use of the another apparatus.

As described above, according to one or more embodiments of the present disclosure, a novel and improved information processing apparatus, information processing method, and recording medium are provided which can remotely limit an operation performed on an authenticating device, after an authentication process has been performed on the authenticating device in response to an authentication request from the authenticating device.

Note that the above advantages are not necessarily limiting. In addition to or instead of the above advantages, any advantages described in the present specification or other advantages arising from the present specification may be achieved.

### BRIEF DESCRIPTION OF THE DRAWINGS

FIG. 1A is an explanatory diagram illustrating an example overall configuration of an information processing system 1 according to an embodiment of the present disclosure;

FIG. 1B is an explanatory diagram illustrating an example overall configuration of an information processing system 1 according to an embodiment of the present disclosure;

FIG. 2 is an explanatory diagram illustrating an example functional configuration of a portable terminal 100 according to an embodiment of the present disclosure;

FIG. 3 is an explanatory diagram illustrating example information stored in a storage unit 150;

FIG. 4 is an explanatory diagram illustrating an example functional configuration of a control unit 110;

FIG. 5 is an explanatory diagram illustrating an example functional configuration of a PC 200 according to an embodiment of the present disclosure;

FIG. 6 is a flowchart illustrating an example operation of an information processing system 1 according to an embodiment of the present disclosure;

FIG. 7 is an explanatory diagram for outlining an example operation of an information processing system 1 according to an embodiment of the present disclosure of FIG. 6;

FIG. 8 is an explanatory diagram illustrating a situation in which the user of a portable terminal 100 is away from a PC 200;

FIG. 9 is an explanatory diagram illustrating a situation in which a third party logs in to a PC 200 while the user of a portable terminal 100 is away from the PC 200;

FIG. 10 is an explanatory diagram illustrating a situation in which, after a third party has logged in to a PC 200, the user of a portable terminal 100 locks the PC 200 using the portable terminal 100;

FIG. 11 is a flowchart illustrating an example operation of an information processing system 1 according to an embodiment of the present disclosure;

FIG. 12 is an explanatory diagram illustrating an example screen which is displayed on a portable terminal 100;

FIG. 13 is a flowchart illustrating an example operation of an information processing system 1 according to an embodiment of the present disclosure;

FIG. 14 is an explanatory diagram illustrating an example screen which is displayed on the portable terminal 100; and

FIG. 15 is an explanatory diagram illustrating an example hardware configuration.

### DETAILED DESCRIPTION OF THE EMBODIMENT(S)

Hereinafter, preferred embodiments of the present disclosure will be described in detail with reference to the appended drawings. Also, throughout the present specification and the drawings, the same reference numerals are given to constituent elements having substantially the same functional configuration and the repeated description thereof will be omitted.

The description will be made in the following order.

1. Background of the present disclosure

2. Embodiment of the present disclosure
2.1. Example of system configuration
2.2. Example of functional configuration
2.3. Example of operation

3. Example of hardware configuration

4. Conclusion

### 1. BACKGROUND OF THE PRESENT DISCLOSURE

The technology described in JP 2005-127050A above securely works when the key device and the vehicle are connected together through radio communication over a short distance (e.g., about one meter), without assuming that the key device and the vehicle are, for example, connected together through radio communication over a distance of no less than several tens of meters. If the smart entry system described in JP 2005-127050A is applied to radio communication over a distance of no less than several tens of meters, then even when the vehicle is located far from the key device, the key device reacts to a call signal from the vehicle, and the door of the vehicle is unlocked. Therefore, there is a risk that the vehicle may be stolen by a third party.

Apparatuses equipped with a radio communication system having a maximum communication range of several tens of meters have in recent years been on the increase. If the authentication system employing a key device, that is described in JP 2005-127050A above, is applied to such apparatuses in order to securely operate the devices, the following problems need to be addressed.

For example, when the key device itself is out of the user's sight, the key device may react to a call signal from the apparatus without the user's knowledge. Also, radio communication between the apparatus and the key device may not necessarily be encrypted. If a response signal containing unique ID information is sent through unencrypted radio communication, the ID signal may be stolen by eavesdropping. Although a number of encryption techniques for radio communication are available, the user's setting decides whether or not to encrypt communication, and therefore, communication data may not necessarily be sufficiently protected.

Unlike car and house keys, when the key device is used to perform authentication for a personal computer or a web service on the Internet which are locked, the following problems need to be addressed. Specifically, when the authentication process is automatically performed in response to an authentication request which is sent from an authenticating device based on a third party's operation performed on the authenticating device, the device is unfortunately used by the third party. The user is supposed to set the key device not to automatically perform the authentication process when the user leaves from the authenticating device. However, when the user forgets to do the setting, the above problem arises, so that the third party cannot be prevented from using the device.

With these circumstances in mind, in an embodiment of the present disclosure, a technique of, when an authentication process is automatically performed in response to an authentication request from an authenticating device, remotely limiting an operation performed on the authenticating device, while maintaining the convenience of using a key device, will be described.

### 2. EMBODIMENT OF THE PRESENT DISCLOSURE

### 2.1. Example of System Configuration

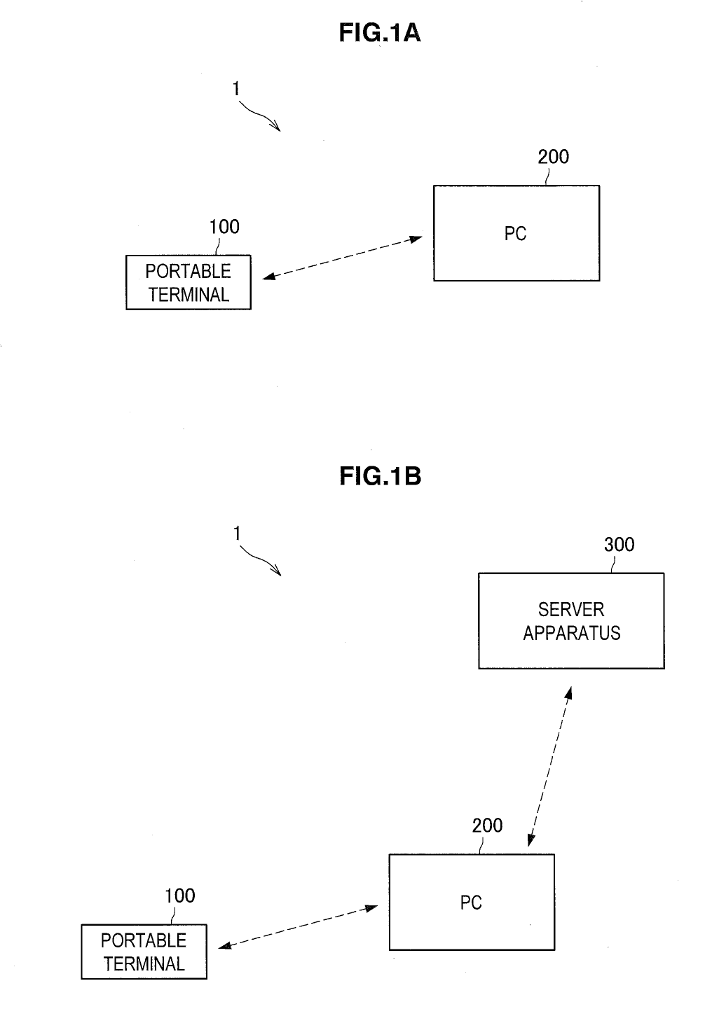

First, an example configuration of an information processing system according to an embodiment of the present disclosure will be described with reference to the drawings. FIG. 1A is an explanatory diagram illustrating an example overall configuration of an information processing system 1 according to an embodiment of the present disclosure. Hereinafter, the example overall configuration of the information processing system 1 according to an embodiment of the present disclosure will be described with reference to FIG. 1A.

As illustrated in FIG. 1A, the information processing system 1 according to an embodiment of the present disclosure is configured to include a portable terminal 100 and a personal computer (PC) 200.

The information processing system 1 according to an embodiment of the present disclosure is a system which authenticates a user who is attempting to use a service provided by the PC 200, according to a password authentication scheme, public key authentication scheme, digital signature scheme, or other authentication schemes. The portable terminal 100 is a device which, when authentication is performed according to a public key authentication scheme, generates and/or stores a pair of a public key pk and a secret key sk. In order to use a service provided by the PC 200, the portable terminal 100 transmits only the public key pk of the generated key pair to the PC 200. When authentication is performed according to a password authentication scheme, the portable terminal 100 stores an ID and password for using the PC 200, for which the portable terminal 100 is to be authenticated (for logging in to the PC 200).

The portable terminal 100 may generate a plurality of pairs of keys instead of only one pair of keys. The portable terminal 100 can set respective different public keys pk in regard to a plurality of services for which authentication is gained by generating a plurality of pairs of keys.

The PC 200 is an apparatus that performs authentication according to a password authentication scheme, public key authentication scheme, or digital signature scheme. The PC 200 previously stores the public key pk which has been generated and transmitted by the portable terminal 100. The PC 200 authenticates a user attempting to use a service, using information generated based on the public key pk received from the portable terminal 100 and the secret key sk corresponding to the public key pk generated by the portable terminal 100. Specifically, the PC 200 performs authentication using a response received from the portable terminal 100, that is made with respect to a challenge produced based on the public key pk, that is transmitted from the PC 200 to the portable terminal 100. In the embodiment, a public key authentication scheme is not limited to a specific scheme. For example, a public key authentication scheme which uses RSA cryptography or a public key authentication scheme which uses elliptic curve cryptography, may be used. Further, a public key authentication scheme using multi-order multivariate simultaneous equations that are difficult to solve as a basis for security may be used, as described in, for example, JP 2012-98690A.

When authentication is performed using a password authentication scheme, the PC 200 obtains an ID and password for using the PC 200 from the portable terminal 100, and performs an authentication process using the obtained ID and password.

The service provided by the PC 200 may include, for example, login or unlocking of the PC 200, execution of an application installed in the PC 200, reproduction of contents (for example, music data, still image data, video data, or electronic book data) on the PC 200, or the like. The process of reproducing contents on the PC 200 may include, for example, a music or video reproduction process, image display process, and electronic book reproduction process. The user of the PC 200 can lock the login or unlocking of the PC 200, the execution of an application installed in the PC 200, the reproduction of contents on the PC 200, or the like, as described above, by generating a pair of keys, i.e., the public key pk and the secret key sk, with the portable terminal 100 and storing the public key pk in the PC 200. When execution of a service locked is being attempted, the PC 200 transmits an authentication request to the portable terminal 100 having the secret key sk corresponding to the public key set for the service, and determines whether or not to authorize the portable terminal 100 to use the service, based on a reply from the portable terminal 100.

The portable terminal 100 may be, for example, a device such as a smartphone, table type terminal, mobile telephone, or PHS or may be, for example, a wearable device of wristwatch type, wristband type, finger ring type, glasses type, etc., or a key chain type device. Any device that can generate and store a pair of keys, i.e., the public key pk and the secret key sk, and communicate with the PC 200 may be used as the portable terminal 100. The PC 200 may be, for example, a television, smartphone, tablet type terminal, glasses type wearable device, camera, camcorder, hard disk recorder, or game device. Any device that can store the public key pk and communicate with the portable terminal 100 may be used as the PC 200.

The communication between the portable terminal 100 and the PC 200 may be wired communication or may be wireless communication. In the following description, the communication between the portable terminal 100 and the PC 200 is assumed to be wireless communication unless otherwise specified. Also, in the wireless communication between the portable terminal 100 and the PC 200, wireless LAN, Bluetooth (registered trademark), ZigBee (registered trademark), or the like may be used, for example.

An example overall configuration of the information processing system 1 according to an embodiment of the present disclosure has been described above with reference to FIG. 1A. Note that the information processing system 1 according to an embodiment of the present disclosure is not limited to the configuration illustrated in FIG. 1A.

FIG. 1B is an explanatory diagram illustrating an example overall configuration of an information processing system 1 according to an embodiment of the present disclosure. Hereinafter, the example overall configuration of the information processing system 1 according to an embodiment of the present disclosure will be described with reference to FIG. 1B.

As illustrated in FIG. 1B, the information processing system 1 according to an embodiment of the present disclosure includes a portable terminal 100, a PC 200, and a server apparatus 300. The configuration of FIG. 1B includes the server apparatus 300 in addition to the configuration of FIG. 1A. In this embodiment, the server apparatus 300 is a web server which provides a service to an authenticated user through the Internet, where the user of the PC 200 is authenticated by causing the user to enter their ID and password to a web browser executed on the PC 200.

Examples of a service (web service) provided by the server apparatus 300 include a social networking service or social networking system (SNS), web mail service, net banking service, and the like.

As in the above example, when a public key authentication scheme is used to perform authentication for a service provided by the server apparatus 300, the portable terminal 100 generates and/or stores a pair of keys used in the service, i.e., a public key pk and a secret key sk. The generated public key pk is provided from the portable terminal 100 to the PC 200 in response to a request from the PC 200. The PC 200 provides the public key pk obtained from the portable terminal 100 to the server apparatus 300 for authentication performed in the server apparatus 300.

Thereafter, the server apparatus 300 performs authentication using an ID and password received from the PC 200, and in addition, performs authentication using a response which the PC 200 has obtained from the portable terminal 100 and then transmitted to the server apparatus 300. Here, the response is made with respect to a challenge which is produced using the public key pk and is transmitted from the server apparatus 300 to the portable terminal 100 through the PC 200.

When authentication is performed on a user of a service provided by the server apparatus 300, the server apparatus 300 may cause the PC 200 to display a screen for allowing the user to select authentication using an ID and a password or authentication using a response to a challenge. The server apparatus 300 may also cause the PC 200 to display a screen corresponding to the result of the selection. Thus, if the user is allowed to select an authentication scheme for each website, the server apparatus 300 does not need to cause a web browser executed on the PC 200 to store a key, and can switch an authentication scheme between authentication using an ID and a password and authentication using a response to a challenge for each website.

### 2.2. Example of Functional Configuration

An example overall configuration of the information processing system 1 according to an embodiment of the present disclosure has been described above with reference to FIG. 1B. Next, an example functional configuration of the portable terminal 100 according to an embodiment of the present disclosure will be described.

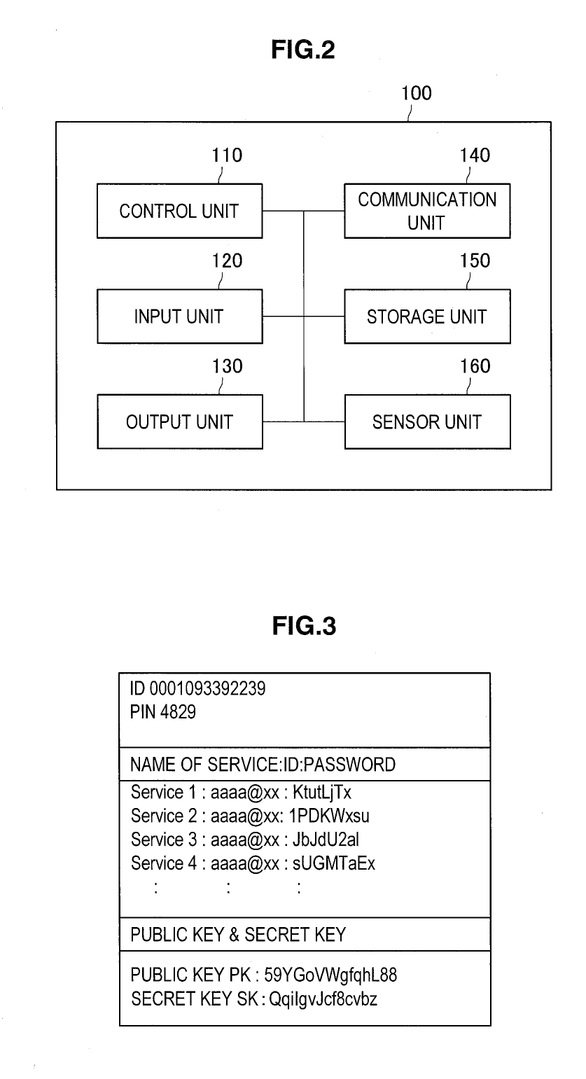

FIG. 2 is an explanatory diagram illustrating an example functional configuration of the portable terminal 100 according to an embodiment of the present disclosure. Hereinafter, the example functional configuration of the portable terminal 100 according to an embodiment of the present disclosure will be described with reference to FIG. 2.

The portable terminal 100 of FIG. 2 is merely an example of the information processing apparatus according to an embodiment of the present disclosure. The portable terminal 100 may be, for example, a device such as a smartphone, table type terminal, portable telephone, or PHS or may be, for example, a wearable device of wristwatch type, wristband type, finger ring type, glasses type, etc., or a key chain type device.

As illustrated in FIG. 2, the portable terminal 100 according to an embodiment of the present disclosure is configured to include a control unit 110, an input unit 120, an output unit 130, a communication unit 140, a storage unit 150, and a sensor unit 160.

The control unit 110 controls an operation of the portable terminal 100. Specifically, each of the constituent elements of the portable terminal 100 of FIG. 2 operates under the control of the control unit 110. The control unit 110, which may be, for example, a microcomputer including a central processing unit (CPU), a read only memory (ROM), a random access memory (RAM), a non-volatile memory unit, and an interface unit, may function as a control unit which controls the entirety of this embodiment. Note that an example functional configuration of the control unit 110 will be described in detail below.

The input unit 120 is an input device which receives the user's input operation. The input unit 120 may be, for example, a touchscreen, keyboard, power supply button, operation button, microphone, or the like.

The output unit 130 is an output device which outputs information which has been processed by the portable terminal 100. The output unit 130 may, for example, be a liquid crystal display, organic EL display, loudspeaker, LED indicator, vibrator, or the like. The output of the output unit 130 may, for example, be generated by the control unit 110.

The communication unit 140 exchanges data with an external device. The external device may be, for example, a computer device, smartphone, smartwatch, network server apparatus, or the like. The communication unit 140 may, for example, be configured to perform network communication via a network access point through radio communication, or direct radio communication with an external device having a compatible communication function, according to a scheme such as wireless LAN, Bluetooth (registered trademark), or the like. The data which the communication unit 140 exchanges with the external device includes information related to an authentication process between the portable terminal 100 and the external device using a secret key generated by the control unit 110. Note that, in addition to information related to an authentication process between the portable terminal 100 and the external device, the communication unit 140 may communicate any data that is to be displayed, such as data of video contents, still image contents, electronic books, etc., computer usable data such as image data, text data, spreadsheet data, etc., that are generated by the portable terminal 100, game images, and the like.

The storage unit 150 may be, for example, a read only memory (ROM), random access memory (RAM), non-volatile memory unit, or the like. The storage unit 150 stores information which is used by the control unit 110 to control the portable terminal 100, computer usable data such as image data, text data, spreadsheet data, etc., that are generated by the portable terminal 100, data of an application performed by the portable terminal 100, or the like. The storage unit 150 also stores information which is necessary during authentication, such as the secret key generated by the control unit 110. It is desirable that an area of the storage unit 150 where the secret key generated by the control unit 110 is stored be tamper-resistant. In addition to the area of the storage unit 150 where the secret key is stored, the entire storage unit 150, the entire control unit 110, or the entire portable terminal 100 may be tamper-resistant.

FIG. 3 is an explanatory diagram illustrating example information stored in the storage unit 150. FIG. 3 illustrates, as example information stored in the storage unit 150, a combination of a user ID, a personal identification number (PIN), an ID and password for using a service provided by the server apparatus 300, and a public key pk and secret key sk which are used when authentication performed according to a public key authentication scheme. Of course, not all of these items of information need to be stored in the storage unit 150.

The number of pairs of an ID and a password stored in the storage unit 150 is not limited to one and may be two or more. The use of each pair of an ID and a password stored in the storage unit 150 may be set to be either permitted or forbidden. If the use of a pair of an ID and a password is permitted, it may be determined whether or not an authentication process is to be automatically performed using the ID and the password.

The number of secret keys sk stored in the storage unit 150 is not limited to one and may be two or more. The use of each secret key sk stored in the storage unit 150 may be set to be permitted or forbidden. If the use of a secret key sk is permitted, it may be determined whether or not an authentication process is to be automatically performed using the secret key sk. If the use of a secret key sk is permitted and it is determined that an authentication process is to be automatically performed using the secret key sk, the portable terminal 100 automatically generates a response to a challenge from the PC 200 using the secret key sk without the user's acknowledgement, and transmits the response to the PC 200.

The sensor unit 160 is a sensor which detects a motion of the portable terminal 100. The sensor unit 160 may be, for example, a sensor, such as an acceleration sensor, gravity sensor, gyroscopic sensor, illuminance sensor, linear acceleration sensor, geomagnetic sensor, near-field sensor, rotation vector sensor, or the like. The sensor unit 160 may be, for example, a sensor which obtains a current position, such as a GPS module. Sensor data obtained by sensing using the sensor unit 160 is acquired by the control unit 110. In this embodiment, sensor data obtained by sensing using the sensor unit 160 may be used in generation of a secret key in the control unit 110.

An example functional configuration of the portable terminal 100 according to an embodiment of the present disclosure has been described above with reference to FIG. 2. Next, an example functional configuration of the control unit 110 included in the portable terminal 100 according to an embodiment of the present disclosure will be described.

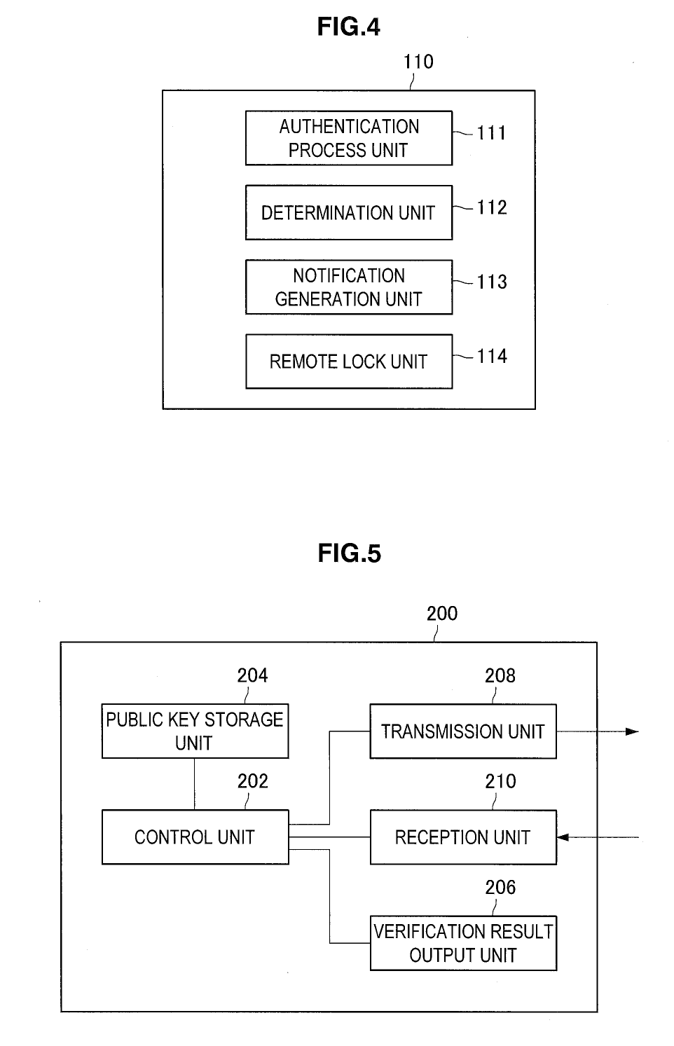

FIG. 4 is an explanatory diagram illustrating an example functional configuration of the control unit 110 included in the portable terminal 100 according to an embodiment of the present disclosure. Hereinafter, the example functional configuration of the control unit 110 included in the portable terminal 100 according to an embodiment of the present disclosure will be described with reference to FIG. 4.

As illustrated in FIG. 4, the control unit 110 is configured to include an authentication process unit 111, a determination unit 112, a notification generation unit 113, and a remote lock unit 114.

The authentication process unit 111, when receiving an authentication request from the PC 200, performs an authentication process between the portable terminal 100 and the PC 200 using information (an ID and a password, or a secret key sk) stored in the storage unit 150. When the PC 200 performs authentication according to a password authentication scheme, the authentication process unit 111 transmits an ID and password stored in the storage unit 150 to the PC 200. When the authentication process between the portable terminal 100 and the PC 200 is performed according to a public key authentication scheme, the authentication process unit 111 performs the process of generating a reply to the authentication request from the PC 200 using the secret key sk. The reply generated by the authentication process unit 111 is transmitted to the PC 200 through the communication unit 140. The PC 200 performs the process of authenticating the portable terminal 100 based on whether or not the reply generated by the authentication process unit 111 is correct.

The determination unit 112 performs a determination process related to the process in the authentication process unit 111. The determination process performed by the determination unit 112 may be, for example, determining whether or not authentication has been successful based on the reply generated by the authentication process unit 111, determining how many times authentication has failed in succession if any, or the like. The determination unit 112 sends the result of the determination process related to the process in the authentication process unit 111 to the notification generation unit 113.

The notification generation unit 113 notifies the user of the result of the process in the authentication process unit 111, that has been received from the determination unit 112, through the output unit 130. The notification generation unit 113 notifies of the determination result of the determination unit 112 using, for example, text, an image, sound, vibration or the like. The notification of the determination result of the determination unit 112 by the notification generation unit 113 allows the user of the portable terminal 100 to know whether or not the portable terminal 100 has been successfully authenticated by the PC 200.

The remote lock unit 114 generates a signal for limiting the use of the PC 200 (i.e., locking the operation of the PC 200). The signal generated by the remote lock unit 114 is transmitted to the PC 200 through the communication unit 140.

In this embodiment, the notification generation unit 113, when authentication between the portable terminal 100 and the PC 200 has been successful according to a public key authentication scheme, generates a notification indicating that the authentication has been successful, and also generates an image containing a button for logging off the PC 200, and causes the output unit 130 to output the image. When the user touches the button for logging off the PC 200, the remote lock unit 114 generates a signal for logging off the PC 200, i.e., a signal for locking the operation of the PC 200, in response to the touch, and causes the communication unit 140 to transmit the signal to the PC 200. The PC 200, when receiving the signal for logging off, automatically performs a logoff process in response to the reception.

The portable terminal 100 according to an embodiment of the present disclosure, which has the configuration of the control unit 110 illustrated in FIG. 4, automatically generates and transmits a reply to an authentication request from the PC 200, which is an authenticating device, to the PC 200, and when the portable terminal 100 has been authenticated by the PC 200 and allowed to operate the PC 200, can remotely limit the operation of the PC 200.

An example functional configuration of the control unit 110 included in the portable terminal 100 according to an embodiment of the present disclosure has been described above with reference to FIG. 4. Next, an example functional configuration of the PC 200 according to an embodiment of the present disclosure will be described.

FIG. 5 is an explanatory diagram illustrating an example functional configuration of the PC 200 according to an embodiment of the present disclosure. Hereinafter, the example functional configuration of the PC 200 according to an embodiment of the present disclosure will be described with reference to FIG. 5.

As illustrated in FIG. 5, the PC 200 according to an embodiment of the present disclosure is configured to include a control unit 202, a public key storage unit 204, a verification result output unit 206, a transmission unit 208, and a reception unit 210.

The control unit 202 controls an operation of the PC 200. That is, each of the constituent elements of the PC 200 illustrated in FIG. 5 operates under the control of the control unit 202. The control unit 202, when authenticating the portable terminal 100 according to a password authentication scheme, performs authentication using an ID and password transmitted from the portable terminal 100. Also, in the case where the control unit 202 authenticates a portable terminal 100 according to a public key authentication scheme, when an authentication request has been transmitted from the PC 200 and then a reply to the authentication request has been received from the portable terminal 100, the control unit 202 authenticates the portable terminal 100 transmitting the reply by verifying the reply.

In the case where the public key storage unit 204 authenticates the portable terminal 100 according to a public key authentication scheme, the public key storage unit 204 stores the public key pk of the pair of keys, i.e., the public key pk and secret key sk generated by the portable terminal 100. The public key pk generated by the portable terminal 100 is received by the reception unit 210 and is stored in the public key storage unit 204 by the control unit 202.

When the authentication request has been transmitted from the PC 200 and then a reply to the authentication request has been received from the portable terminal 100, the verification result output unit 206 outputs an image, audio, vibration, or the like indicating the result of verifying the reply.

The transmission unit 208 wirelessly transmits information to the portable terminal 100. The information transmitted to the portable terminal 100 by the transmission unit 208 includes, for example, a request which asks the portable terminal 100 to send the public key pk or an authentication request using the public key pk stored in the public key storage unit 204 in the case where the portable terminal 100 is authenticated according to a public key authentication scheme.

The reception unit 210 receives information which is wirelessly transmitted from the portable terminal 100. For example, when the portable terminal 100 is authenticated according to a public key authentication scheme, the information received by the reception unit 210 from the portable terminal 100 includes the public key pk which is transmitted to the PC 200 in response to the request for sending of the public key pk, or a reply which is transmitted in response to the authentication request using the public key pk. For example, when the portable terminal 100 is authenticated according to a password authentication scheme, the information received by the reception unit 210 from the portable terminal 100 includes a pair of an ID and a password.

An example functional configuration of the PC 200 according to an embodiment of the present disclosure has been described above with reference to FIG. 5. Next, an example operation of the information processing system 1 according to an embodiment of the present disclosure will be described.

### 2.3. Example of Operation

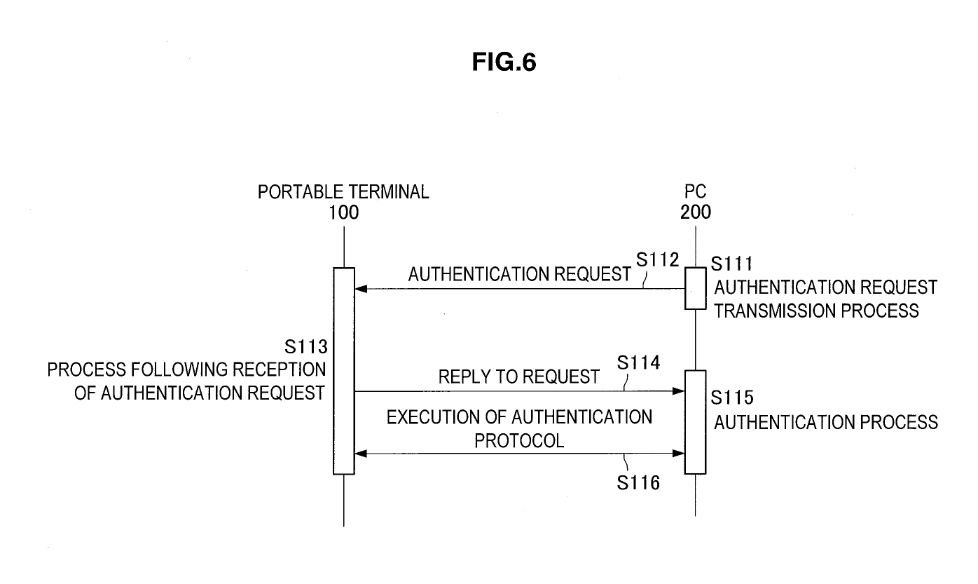

FIG. 6 is a flowchart illustrating an example operation of the information processing system 1 according to an embodiment of the present disclosure. The flowchart illustrated in FIG. 6 illustrates an example authentication process using the public key pk stored in the PC 200 in the case where the portable terminal 100 is authenticated according to a public key authentication scheme. Hereinafter, the example operation of the information processing system 1 according to an embodiment of the present disclosure will be described with reference to FIG. 6.

When the PC 200 performs the authentication process using the public key pk, the control unit 202 first performs an authentication request transmission process (step S111). The authentication request transmission process may be performed in various situations. The authentication request transmission process may be performed when the user of the PC 200 is attempting, for example, to log in to the PC 200, to unlock the PC 200, to execute an application installed in the PC 200, to perform any process using an application installed in the PC 200, or to reproduce a content on the PC 200. The process using an application installed in the PC 200 may include, for example, a process of attempting to access a specific page using a web browser, and a process of editing a document using document generation software. Also, the process of reproducing a content on the PC 200 may include, for example, a music or moving image reproduction process, image display process, and electronic book reproduction process.

Note that it is assumed that when the authentication request transmission process is performed in step S111, a predetermined communication link for communicating authentication information has been previously established between the portable terminal 100 and the PC 200, or that when the PC 200 performs the authentication request transmission process, an attempt is made to establish the above communication link between the portable terminal 100 and the PC 200. Between the portable terminal 100 and the PC 200, network communication via a network access point through radio communication, or direct wireless communication, may be performed according to a scheme such as wireless LAN, Bluetooth (registered trademark), or the like.

After the authentication request transmission process has been performed in step S111, the PC 200 wirelessly transmits an authentication request to the portable terminal 100 through the transmission unit 208 (step S112). The authentication request may contain information which allows the portable terminal 100 to identify the authentication request as originating from the PC 200. The portable terminal 100, when receiving the authentication request wirelessly transmitted from the transmission unit 208 through the reception unit 120 in step S112, performs a process following the reception of the authentication request (step S113).

Here, the information which is transmitted from the PC 200 to the portable terminal 100 in step S112, may, for example, contain a challenge which is generated by the PC 200 during challenge-response authentication according to a public key authentication scheme. When the PC 200 generates the challenge using the public key pk, the process of step S113 which is performed by the portable terminal 100, following the reception of the authentication request, includes the process of generating a response to the challenge transmitted from the PC 200 using the secret key sk corresponding to the public key pk, that is stored in the storage unit 150, by the control unit 110, particularly the authentication process unit 111.

The PC 200 may add predetermined signature information to the challenge contained in the authentication request which is transmitted in step S112. For example, a date and time at which the challenge is generated may be used as the predetermined signature information. When the PC 200 transmits the challenge with the predetermined signature information added, the portable terminal 100 can be caused to return a response including the signature information. In this case, the PC 200 can determine whether or not the response is related to the challenge generated by the PC 200 itself by checking the signature information included in the response.

After the process following the reception of the authentication request has been performed in step S113, the portable terminal 100 wirelessly transmits the reply to the authentication request to the PC 200 through the communication unit 140 (step S114). The reply to the authentication request which is wirelessly transmitted through the communication unit 140 in step S114 includes the response to the challenge which has been generated in step S113.

The PC 200, when receiving the reply to the authentication request wirelessly transmitted from the portable terminal 100 in step S114, performs the authentication process using the response included in the reply (step S115). The authentication process of step S115 may be performed by the control unit 202. In addition, the authentication process of step S115 is performed by determining whether or not the response included in the reply from the portable terminal 100 has a correct answer value.

When more than one round-trip interaction is necessary in the authentication process, the PC 200 performs a predetermined authentication protocol necessary between the PC 200 and the portable terminal 100 (step S116) after the authentication process has been performed in step S115. The authentication protocol may be performed as necessary, and may not necessarily be performed, for example, when the authentication process is completed by one round-trip interaction.

The transmission of the challenge from the PC 200 to the portable terminal 100 or the transmission of the response to the challenge from the portable terminal 100 to the PC 200, as described above, may be performed a plurality of times. By transmitting the challenge and the response a plurality of times, it is possible to improve the security of authentication according to a public key authentication scheme.

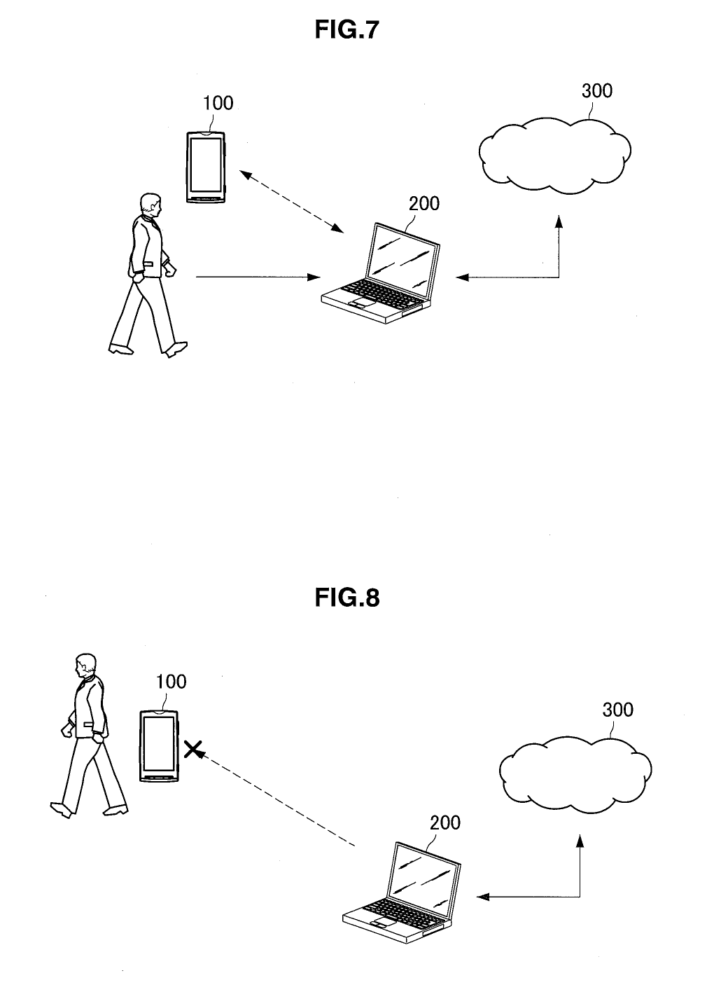

FIG. 7 is an explanatory diagram for outlining an example operation of the information processing system 1 according to an embodiment of the present disclosure of FIG. 6. While the portable terminal 100 is held by the user within a distance at which the portable terminal 100 and the PC 200 can perform radio communication, the user instructs the PC 200 using a user interface provided by the PC 200 to start authentication. At this time, the user has yet to log in to the PC 200, and the PC 200 is ready to receive only the operation of instructing the PC 200 to start authentication. The operation of instructing the PC 200 to start authentication may be, for example, clicking on a button, or the like.

After having been instructed to start authentication, the PC 200 transmits a challenge generated using a true random number generator or pseudorandom number generator, to the portable terminal 100. The portable terminal 100 generates a response to the challenge received from the PC 200 using the secret key sk, and returns the response to the PC 200. The PC 200 can determine whether or not the portable terminal 100 transmitting the response has the secret key sk corresponding to the public key pk, by determining whether or not the response received by the portable terminal 100 has a correct answer value. Thereafter, if the portable terminal 100 transmitting the response has the secret key sk corresponding to the public key pk, the PC 200 determines that the user having the secret key sk is allowed to use the PC 200, and starts a login process for the user corresponding to the public key pk.

Note that, in addition to the authentication process between the portable terminal 100 and the PC 200, the authentication process is similarly performed between the portable terminal 100 and the server apparatus 300 through the PC 200. Specifically, the portable terminal 100 previously provides the public key pk to the server apparatus 300 for authentication performed in the server apparatus 300. The server apparatus 300 performs authentication using a response which is obtained by the PC 200 from the portable terminal 100 and is transmitted by the PC 200. Here, the response is made to a challenge which is transmitted from the server apparatus 300 to the portable terminal 100 through the PC 200, the challenge being produced using the stored public key pk.

When the user leaves the PC 200, the PC 200 is locked (i.e., the user logs off the PC 200), and in addition, the use of the key function of the portable terminal 100 is forbidden. When the PC 200 is locked and the use of the key function of the portable terminal 100 is forbidden, then even if the PC 200 and the portable terminal 100 are within the range in which the PC 200 and the portable terminal 100 can perform radio communication, the portable terminal 100 does not automatically respond to an authentication request from the PC 200. FIG. 8 is an explanatory diagram illustrating a situation in which the user of the portable terminal 100 is away from the PC 200. Even when the user of the portable terminal 100 is away from the PC 200 as illustrated in FIG. 8, then if the use of the key function of the portable terminal 100 is forbidden as described above, the portable terminal 100 does not automatically respond to an authentication request even when a third party comes to the PC 200 and instructs the PC 200 to start authentication, and therefore, is not allowed to automatically log in to the PC 200.

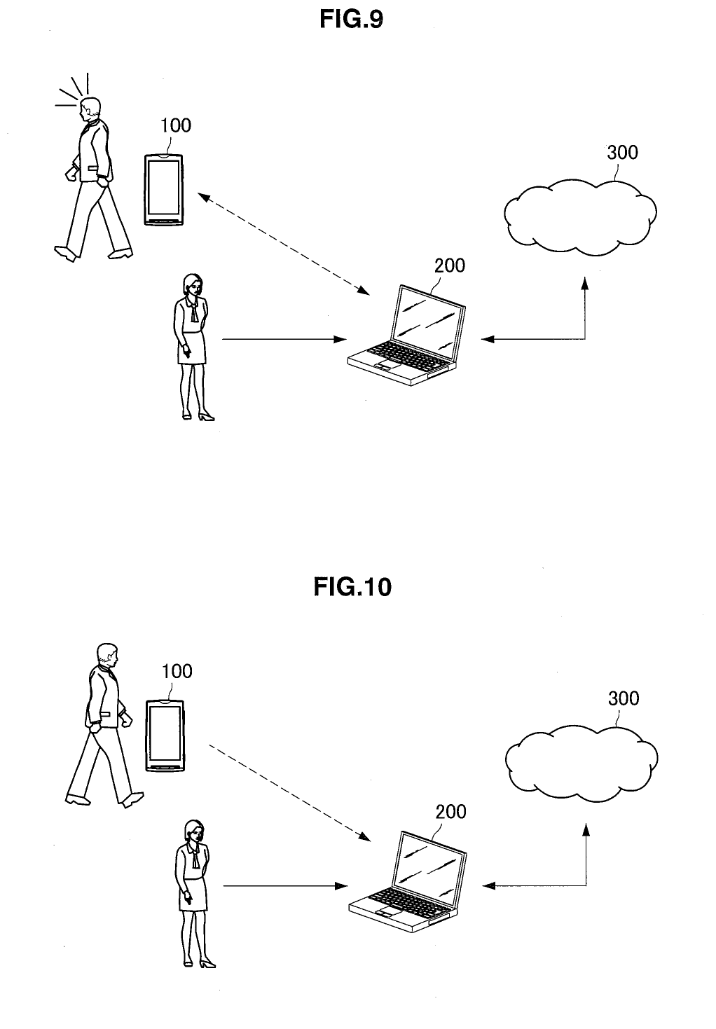

However, if the user of the portable terminal 100, when leaving the PC 200, forgets to forbid the use of the key function of the portable terminal 100, then when a third party comes to the PC 200 and instructs the PC 200 to start authentication, the above authentication process is performed, so that the third party automatically logs in to the PC 200, if the PC 200 and the portable terminal 100 are within the range in which the PC 200 and the portable terminal 100 can perform radio communication. FIG. 9 is an explanatory diagram illustrating a situation in which a third party logs in to the PC 200 while the user of the portable terminal 100 is away from the PC 200. If a third party has successfully logged in to the PC 200 in this manner, the PC 200 is unauthorizedly used, e.g., information is stolen, a service provided by the server apparatus 300 is used in an unintended fashion, or the like. Therefore, it is necessary to provide a way of locking or logging off the PC 200 immediately after a third party has logged in to the PC 200 while the user of the portable terminal 100 is away from the PC 200.

Therefore, in this embodiment, when an authentication process is automatically performed between the portable terminal 100 and the PC 200, and the portable terminal 100 is then successfully authenticated by the PC 200, the portable terminal 100 performs the process of notifying the user that the authentication has been successful in the PC 200. By the portable terminal 100 performing the process of notifying the user that the authentication has been successful in the PC 200, the user of the portable terminal 100 can know whether or not the authentication is what is intended by the user. If the authentication is not what is intended by the user, the portable terminal 100 generates a signal for locking the PC 200 and transmits the signal to the PC 200 according to the user's instruction. FIG. 10 is an explanatory diagram illustrating a situation in which, after a third party has logged in to the PC 200, the user of the portable terminal 100 locks the PC 200 using the portable terminal 100. The notification from the portable terminal 100 allows the user to know that authentication has been successful in the PC 200, and therefore, the user can lock the PC 200 using the portable terminal 100, leading to prevention or reduction of unauthorized use of the PC 200.

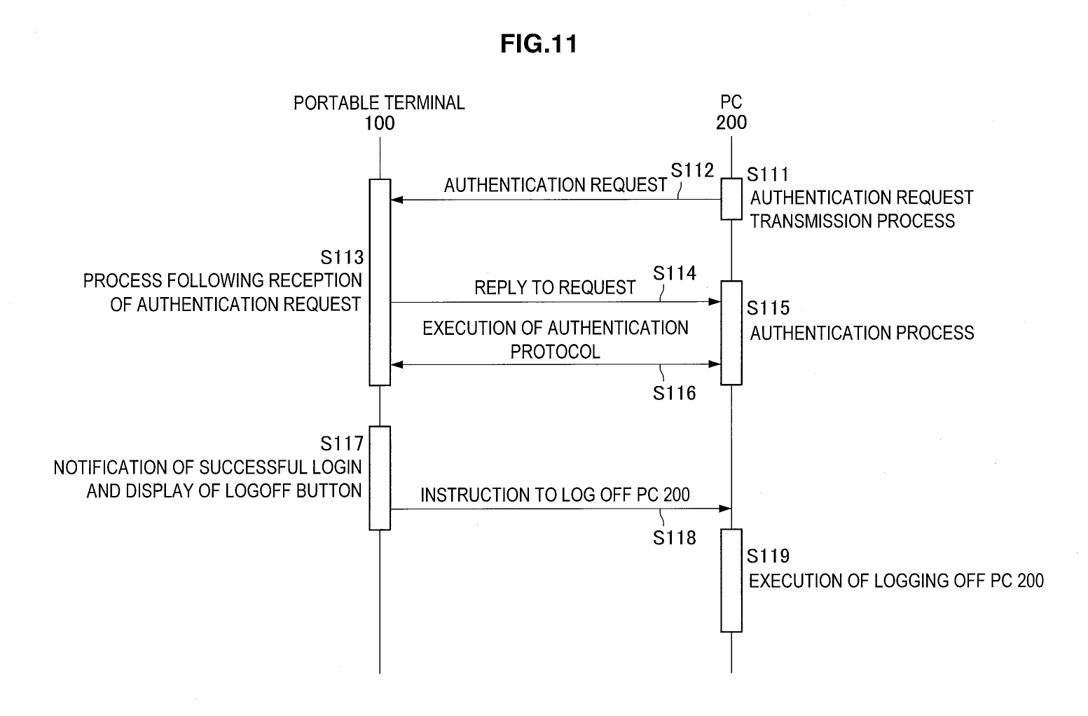

FIG. 11 is a flowchart illustrating an example operation of the information processing system 1 according to an embodiment of the present disclosure. The flowchart of FIG. 11 illustrates an example authentication process using the public key pk stored in the PC 200, which is performed when the portable terminal 100 is authenticated according to a public key authentication scheme. The flowchart of FIG. 11 includes, in addition to the flowchart of FIG. 6, step S117 and those following it.

If, in step S116, the PC 200 has performed a predetermined authentication protocol that is necessary between the PC 200 and the portable terminal 100, and the authentication has been successful, the portable terminal 100 notifies that login to the PC 200 has been successful and displays a logoff button (step S117). The process of step S117 is, for example, performed based on information generated by the notification generation unit 113. The portable terminal 100 may notify that login to the PC 200 has been successful, by any one or combination of display of a message on a screen, vibration of a vibrator, output of sound, and emission of LED light, and the like. The portable terminal 100 also displays a logoff button in addition to the message displayed on the screen.

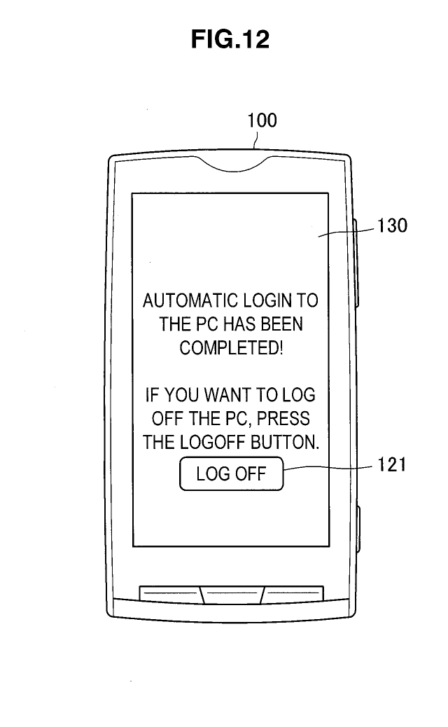

FIG. 12 is an explanatory diagram illustrating an example screen which is displayed on the portable terminal 100 when the authentication process has been successful between the portable terminal 100 and the PC 200. FIG. 12 illustrates a situation in which a message indicating that login to the PC 200 has been successful, and a logoff button 121, are displayed on the output unit 130.

If login to the PC 200 is not what is intended by the user (e.g., login of a third party), the user of the portable terminal 100 touches the logoff button 121, so that the portable terminal 100 generates a signal for logging off the PC 200, and transmits the signal to the PC 200 (step S118). The generation of the signal for logging off the PC 200 may be performed by the remote lock unit 114, and the transmission of the signal may be performed by the communication unit 140.

In FIG. 12, the message indicating that login to the PC 200 has been completed is displayed on the output unit 130. In addition, if the authentication process between the portable terminal 100 and the PC 200 has not been successful, so that login to the PC 200 has failed, the portable terminal 100 may output a message indicating that login to the PC 200 has failed, to the output unit 130.

The PC 200, when receiving the signal for logging off the PC 200 from the portable terminal 100, performs the process of logging off the PC 200 (step S119). The portable terminal 100 generates and transmits the signal for logging off the PC 200 to the PC 200, thereby remotely logging off the PC 200. By remotely logging off the PC 200, the portable terminal 100 can prevent or reduce the exacerbation of unauthorized use of the PC 200 which is caused by automatically logging in to the PC 200 without the user's knowledge.

Note that after the authentication process between the PC 200 and the portable terminal 100 has been successful, the portable terminal 100 waits for a signal for logging off the PC 200. However, this leads to an increase in power consumption if the portable terminal 100 continues to wait for the signal. Therefore, if the authentication process between the PC 200 and the portable terminal 100 has been successful, the portable terminal 100 may display a screen, such as that illustrated in FIG. 12, for a predetermined period of time, and the PC 200 may also wait for a signal for logging off the PC 200 for a predetermined period of time.

The foregoing example illustrates an example operation which is performed when the portable terminal 100 is authenticated according to a public key authentication scheme. Alternatively, when the portable terminal 100 is authenticated according to a password authentication scheme, a process similar to that of FIG. 11 may be performed. When the portable terminal 100 is authenticated according to a password authentication scheme, the portable terminal 100 transmits an ID and password for the PC 200 in response to an authentication request from the PC 200. Thereafter, after the portable terminal 100 has logged in to the PC 200 using the ID and the password, the PC 200 notifies the portable terminal 100 that the authentication has been completed, and the portable terminal 100 notifies that login to the PC 200 has been successful, and displays a logoff button.

The foregoing example illustrates a process which is performed when a user logs into the PC 200 using the portable terminal 100. Also, when the portable terminal 100 is used to log in to a service provided by the server apparatus 300 through the PC 200, it is similarly possible to remotely log off the service provided by the server apparatus 300.

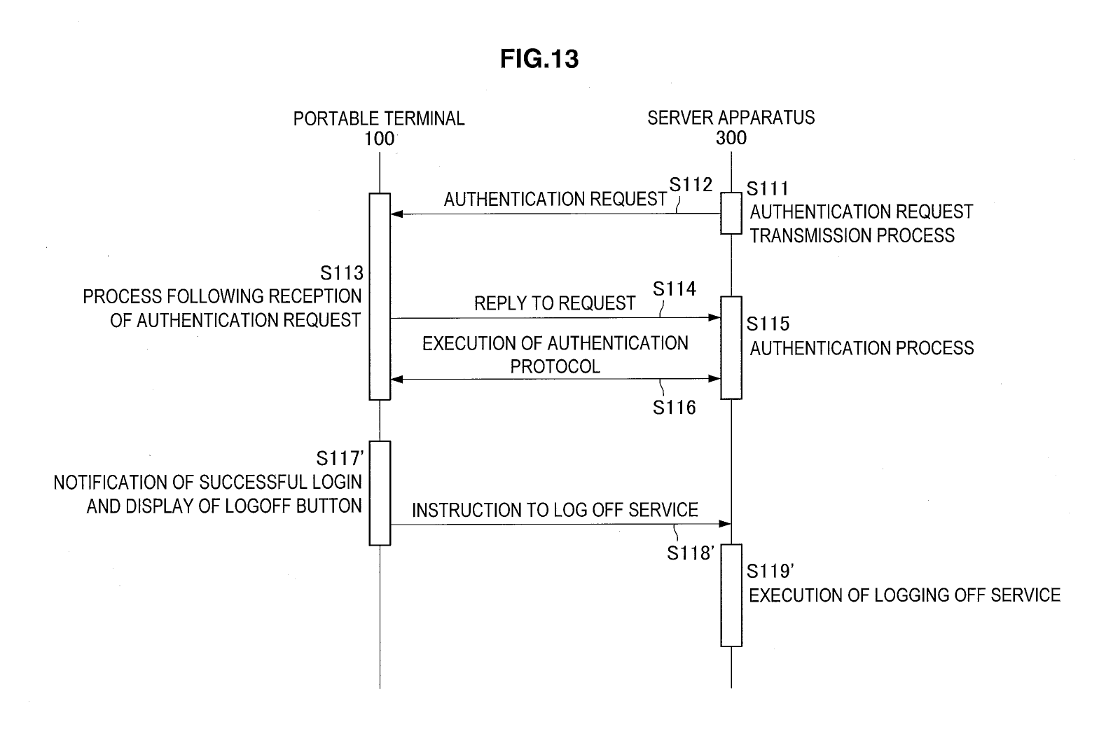

FIG. 13 is a flowchart illustrating an example operation of the information processing system 1 according to an embodiment of the present disclosure. The flowchart of FIG. 13 illustrates an example authentication process using the public key pk stored in the server apparatus 300. The flowchart of FIG. 13 includes, in addition to the flowchart of FIG. 6, step S117′ and those following it. Note that, in the example of FIG. 13, it is assumed that login to the service provided by the server apparatus 300 has been completed by a series of steps until step S116.

If, in step S116, the server apparatus 300 has performed a predetermined authentication protocol between the server apparatus 300 and the portable terminal 100, through the PC 200, and the authentication has been successful, the portable terminal 100 notifies that login to the service provided by the server apparatus 300 has been successful, and displays a logoff button (step S117′). The process of step S117′ is, for example, performed based on information generated by the notification generation unit 113. The portable terminal 100 may notify that login to the service provided by the server apparatus 300 has been successful, for example, by display of a message on a screen, vibration of a vibrator, output of sound, emission of LED light, or the like. The portable terminal 100 also displays a logoff button in addition to the message displayed on the screen.

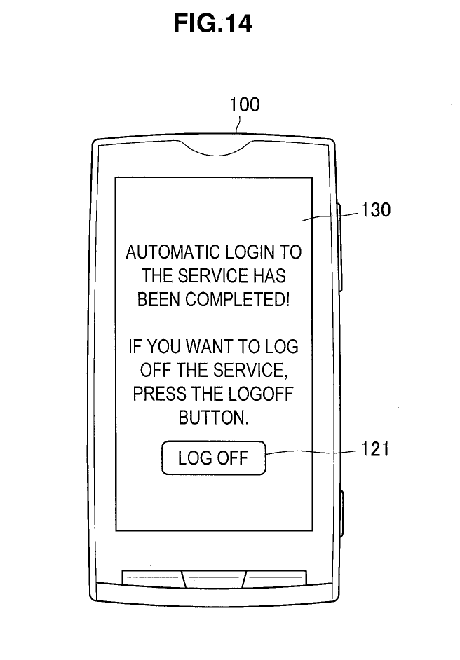

FIG. 14 is an explanatory diagram illustrating an example screen which is displayed on the portable terminal 100 when the authentication process between the portable terminal 100 and the server apparatus 300 has been successful. FIG. 14 illustrates a situation in which a message indicating that login to the service provided by the server apparatus 300 has been completed, and a logoff button 121, are displayed on the output unit 130.

In FIG. 14, the message indicating that the service provided by the server apparatus 300 has been completed is displayed on the output unit 130. If the authentication process between the portable terminal 100 and the server apparatus 300 has not been successful, so that login to the service provided by the server apparatus 300 has failed, the portable terminal 100 may output a message indicating that login to the service provided by the server apparatus 300 has failed, to the output unit 130.

If login to the service provided by the server apparatus 300 is not what is intended by the user (e.g., login of a third party), the user of the portable terminal 100 touches the logoff button 121, so that the portable terminal 100 generates a signal for logging off the service provided by the server apparatus 300, and sends the signal to the server apparatus 300 through the PC 200 (step S118′). The generation of the signal for logging off the service provided by the server apparatus 300 may be performed by the remote lock unit 114, and the transmission of the signal may be performed by the communication unit 140.

The server apparatus 300, when receiving the signal for logging off the service provided by the server apparatus 300 from the portable terminal 100, performs the process of logging off the service (step S119′). The portable terminal 100 generates and transmits the signal for logging off the service provided by the server apparatus 300 to the server apparatus 300, thereby remotely logging off the service provided by the server apparatus 300. By remotely logging off the service provided by the server apparatus 300, the portable terminal 100 can prevent or reduce the exacerbation of unauthorized use of the service provided by the server apparatus 300 which is caused by automatically logging in to the service without the user's knowledge.

The portable terminal 100 according to an embodiment of the present disclosure remotely logs off the PC 200 or the service provided by the server apparatus 300, whereby the exacerbation of unauthorized use can be prevented or reduced, and an effective deterrent can be provided against a third party attempting unauthorized use. After logoff, the third party may continue to attempt unauthorized use. In this case, if the portable terminal 100 has remotely logged off a plurality of times in succession, the use of the secret key sk used in the authentication may be automatically forbidden, or a screen for causing the user to determine whether or not to set the secret key sk for authentication not to be used may be output, under the control of the control unit 110, for example. When the portable terminal 100 has remotely logged off a plurality of times in succession, then if the portable terminal 100 automatically forbids the use of the secret key sk in the authentication, or causes the user to determine whether or not to set the secret key sk for authentication not to be used, unauthorized use by a third party can be prevented completely.

### 3: EXAMPLE OF HARDWARE CONFIGURATION

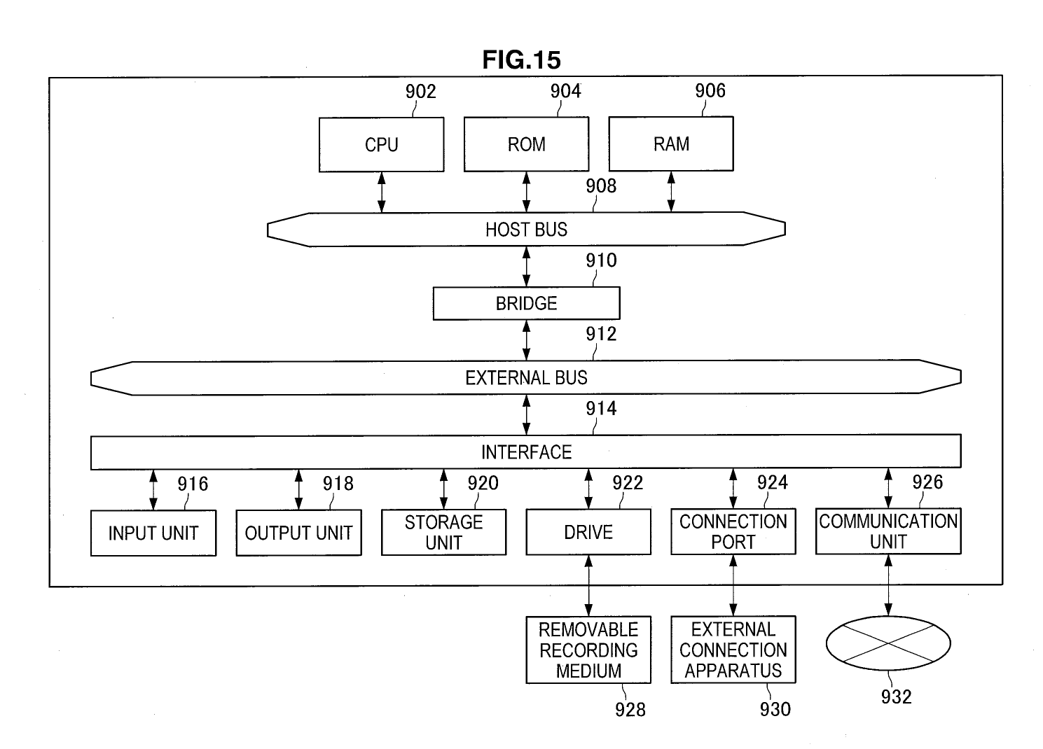

Each algorithm described above can be performed by using, for example, a hardware configuration of the information processing apparatus illustrated in FIG. 15. That is, the process of each algorithm can be carried out by controlling the hardware illustrated in FIG. 15 using a computer program. Additionally, this hardware may be provided in any form including, for example, a personal computer, mobile information terminal such as a mobile phone, PHS or PDA, game machine, contact or non-contact IC chip, contact or non-contact IC card, or various information appliances. Moreover, PHS is an abbreviation for Personal Handy-phone System. Also, PDA is an abbreviation for Personal Digital Assistant.

As illustrated in FIG. 15, this hardware mainly includes a CPU 902, a ROM 904, a RAM 906, a host bus 908, and a bridge 910. This hardware further includes an external bus 912, an interface 914, an input unit 916, an output unit 918, a storage unit 920, a drive 922, a connection port 924, and a communication unit 926. CPU is an abbreviation for Central Processing Unit. ROM is an abbreviation for Read Only Memory. RAM is an abbreviation for Random Access Memory.

The CPU 902 functions as an arithmetic processing unit or a control unit, for example, and controls all or a part of the operation of each constituent element based on various programs stored in the ROM 904, the RAM 906, the storage unit 920, or a removable recording medium 928. The ROM 904 is a device for storing, for example, a program to be loaded on the CPU 902 or data or the like used in an arithmetic operation. The RAM 906 temporarily or permanently stores, for example, a program to be loaded on the CPU 902 or various parameters or the like suitably changed in execution of the program.

These constituent elements are, for example, connected to each other by the host bus 908 capable of performing high-speed data transmission. The host bus 908 is, for example, connected through the bridge 910 to the external bus 912 having a relatively low data transmission speed. The input unit 916 is, for example, a mouse, keyboard, touch panel, button, switch, or lever. Also, the input unit 916 may be a remote control that can transmit a control signal by using infrared light or other radio waves. The input unit 916 may be various sensors, such as a geomagnetic sensor, acceleration sensor, or the like, or something which obtains a current position, such as a GPS or the like.

The output unit 918 is, for example, a display device such as a CRT, LCD, PDP or ELD, audio output device such as a speaker or headphone, printer, mobile phone, or fax machine, that can visually or audibly notify a user of acquired information. CRT is an abbreviation for Cathode Ray Tube. LCD is an abbreviation for Liquid Crystal Display. PDP is an abbreviation for Plasma Display Panel. ELD is an abbreviation for Electro-Luminescence Display.

The storage unit 920 is a device for storing various types of data. The storage unit 920 is, for example, a magnetic storage device such as a hard disk drive (HDD) or the like, semiconductor storage device, optical storage device, or magneto-optical storage device. HDD is an abbreviation for Hard Disk Drive.

The drive 922 is a device that reads information stored on the removable recording medium 928 such as a magnetic disk, optical disk, magneto-optical disk, or semiconductor memory, or writes information to the removable recording medium 928. The removable recording medium 928 is, for example, a DVD medium, Blu-ray medium, HD-DVD medium, various types of semiconductor storage media, or the like. Of course, the removable recording medium 928 may be, for example, an IC card on which a non-contact IC chip is mounted, or an electronic device. IC is an abbreviation for Integrated Circuit.

The connection port 924 is a port such as an USB port, IEEE1394 port, SCSI, RS-232C port, or port for connecting an externally connected device 930 such as an optical audio terminal. The externally connected device 930 is, for example, a printer, mobile music player, digital camera, digital video camera, or IC recorder. USB is an abbreviation for Universal Serial Bus. SCSI is an abbreviation for Small Computer System Interface.

The communication unit 926 is a communication device for connecting to a network 932, and is, for example, a communication card for a wired or wireless LAN, Bluetooth (registered trademark), or WUSB, optical communication router, ADSL router, or device for contact or non-contact communication. The network 932 connected to the communication unit 926 is configured from a wired or wireless network, and is, for example, the Internet, a home LAN, infrared communication, visible light communication, broadcasting, or satellite communication. LAN is an abbreviation for Local Area Network. WUSB is an abbreviation for Wireless USB. ADSL is an abbreviation for Asymmetric Digital Subscriber Line.

For example, when the portable terminal 100 has such a hardware configuration, the functionality of the control unit 110 may, for example, be carried out by the CPU 902. The functionality of the input unit 120 may, for example, be carried out by the input unit 916. The functionality of the output unit 130 may, for example, be carried out by the output unit 918. The functionality of the communication unit 140 may, for example, be carried out by the communication unit 926. The functionality of the storage unit 140 may, for example, be carried out by the ROM 904, RAM 906, storage unit 920, or removable recording medium 928. The functionality of the sensor unit 160 may, for example, be carried out by the input unit 916.

### 4. CONCLUSION

As described above, according to an embodiment of the present disclosure, the portable terminal 100 is provided which can prevent or reduce the exacerbation of unauthorized use of an authenticating device or service which is caused by an authentication process without the user's knowledge. The portable terminal 100 according to an embodiment of the present disclosure automatically responds to an authentication request from an authenticating device or service, and notifies the user that the response has been automatically made. The user of the portable terminal 100 checks the notification provided by the portable terminal 100, and if an authentication process which is not intended by the user themselves has been performed, instructs the portable terminal 100 to lock the authenticating device or service.

The portable terminal 100 according to an embodiment of the present disclosure, when the user has determined that the authentication process is not what is intended by the user, locks the authenticating device or service, whereby the exacerbation of unauthorized use of the authenticating device or service can be prevented or reduced.

The steps in the processes performed by each apparatus in the present specification may not necessarily be processed chronologically in the orders described in the sequence diagrams and the flowcharts. For example, the steps in the processes performed by each apparatus may be processed in different orders from the orders described in the flowcharts or may be processed in parallel.

Also, a computer program causing hardware such as a CPU, a ROM, and a RAM included in each apparatus to carry out the equivalent functions as the above-described configuration of each apparatus can be generated. Also, a storage medium having the computer program stored therein can be provided. Also, by configuring each functional block illustrated in the functional block diagram as hardware, the series of processes can also be realized by the hardware. Also, the computer program can be distributed as a dedicated application program for various information processing terminals such as smartphones or tablets from a predetermined application distribution site on a network such as the Internet. The application distribution site can be provided by a server apparatus including a storage apparatus that stores a program and a communication apparatus that transmits the application program in response to a download request from clients (various information processing terminals such as smartphones or tablets).

It should be understood by those skilled in the art that various modifications, combinations, sub-combinations and alterations may occur depending on design requirements and other factors insofar as they are within the scope of the appended claims or the equivalents thereof.

For example, in the above embodiment, when an authentication process between the portable terminal 100 and the PC 200 or the server apparatus 300 has been automatically performed, the portable terminal 100 displays the result of the authentication process on the screen, and in addition, a user interface for logging off the PC 200 or the service provided by the server apparatus 300. The present disclosure is not limited to such an example. For example, when the portable terminal 100 does not include a display, then if an authentication process between the portable terminal 100 and the PC 200 or the server apparatus 300 is automatically performed, the portable terminal 100 may transmit a signal for logging off the PC 200 or the service provided by the server apparatus 300, to the PC 200, in response to the user's operation of pressing down a predetermined button.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1) An information processing apparatus including:

an authentication process unit configured to obtain an authentication request from another apparatus, and perform an authentication process between the information processing apparatus and the another apparatus in response to the authentication request; and

a notification generation unit configured to, when the authentication process unit performs the authentication process between the information processing apparatus and the another apparatus, generate information for notifying a result of the authentication process and information for limiting use of the another apparatus.

(2) The information processing apparatus according to (1), wherein

the notification generation unit outputs the information for limiting the use of the another apparatus for a predetermined period of time.

(3) The information processing apparatus according to (1) or (2), further including:

a communication unit configured to transmit a signal for limiting the use of the another apparatus to the another apparatus based on an operation with respect to the information for limiting the use of the another apparatus output by the notification generation unit.

(4) The information processing apparatus according to (3), wherein

the signal for limiting the use of the another apparatus is a signal for logging off the another apparatus.

(5) The information processing apparatus according to (3), wherein

the signal for limiting the use of the another apparatus is a signal for logging off a service to which a user has logged in through the another apparatus.

(6) The information processing apparatus according to any one of (3) to (5), wherein

if the signal for limiting the use of the another apparatus is transmitted from the communication unit a plurality of times in succession, the authentication process unit is set to refrain from performing the authentication process corresponding to the authentication request even when receiving the authentication request from the another apparatus.

(7) The information processing apparatus according to any one of (3) to (5), wherein

if the signal for limiting the use of the another apparatus is transmitted from the communication unit a plurality of times in succession, then when the authentication process unit receives the authentication request from the another apparatus, the authentication process unit determines whether or not to perform the authentication process corresponding to the authentication request.

(8) The information processing apparatus according to any one of (1) to (7), further including:

a storage unit configured to store information for the authentication process.

(9) The information processing apparatus according to any one of (1) to (8), wherein

the authentication process is a public key authentication process.

(10) The information processing apparatus according to any one of (1) to (8), wherein

the authentication process is a password authentication process.

(11) The information processing apparatus according to any one of (1) to (10), wherein

the notification generation unit generates information for performing notification of a result of the authentication process by information display on a screen.

(12) The information processing apparatus according to any one of (1) to (11), wherein

the notification generation unit generates information for performing notification of a result of the authentication process by vibration of a predetermined vibration member.

(13) An information processing method including:

obtaining an authentication request from another apparatus, and performing an authentication process between an information processing apparatus and the another apparatus in response to the authentication request; and

generating, when the authentication process is performed between the information processing apparatus and the another apparatus, information for notifying a result of the authentication process and information for limiting use of the another apparatus.

(14) A non-transitory computer-readable recording medium having a program recorded thereon, the program causing a computer to execute:

obtaining an authentication request from another apparatus, and performing an authentication process between an information processing apparatus and the another apparatus in response to the authentication request; and

generating, when the authentication process is performed between the information processing apparatus and the another apparatus, information for notifying a result of the authentication process and information for limiting use of the another apparatus.

What is claimed is:

1. An information processing apparatus comprising:
an authentication process unit configured to obtain an authentication request from another apparatus, and perform an authentication process between the information processing apparatus and the another apparatus in response to the authentication request; and
a notification generation unit configured to, when the authentication process unit performs the authentication process between the information processing apparatus and the another apparatus, generate information for notifying a result of the authentication process and information for limiting use of the another apparatus.

2. The information processing apparatus according to claim 1, wherein
the notification generation unit outputs the information for limiting the use of the another apparatus for a predetermined period of time.

3. The information processing apparatus according to claim 1, further comprising:
a communication unit configured to transmit a signal for limiting the use of the another apparatus to the another apparatus based on an operation with respect to the information for limiting the use of the another apparatus output by the notification generation unit.

4. The information processing apparatus according to claim 3, wherein
the signal for limiting the use of the another apparatus is a signal for logging off the another apparatus.

5. The information processing apparatus according to claim 3, wherein
the signal for limiting the use of the another apparatus is a signal for logging off a service to which a user has logged in through the another apparatus.

6. The information processing apparatus according to claim 3, wherein
if the signal for limiting the use of the another apparatus is transmitted from the communication unit a plurality of times in succession, the authentication process unit is set to refrain from performing the authentication process corresponding to the authentication request even when receiving the authentication request from the another apparatus.

7. The information processing apparatus according to claim 3, wherein
if the signal for limiting the use of the another apparatus is transmitted from the communication unit a plurality of times in succession, then when the authentication process unit receives the authentication request from the another apparatus, the authentication process unit determines whether or not to perform the authentication process corresponding to the authentication request.

8. The information processing apparatus according to claim 1, further comprising:
a storage unit configured to store information for the authentication process.

9. The information processing apparatus according to claim 1, wherein
the authentication process is a public key authentication process.

10. The information processing apparatus according to claim 1, wherein
the authentication process is a password authentication process.

11. The information processing apparatus according to claim 1, wherein
the notification generation unit generates information for performing notification of a result of the authentication process by information display on a screen.

12. The information processing apparatus according to claim 1, wherein
the notification generation unit generates information for performing notification of a result of the authentication process by vibration of a predetermined vibration member.

13. An information processing method comprising:
obtaining an authentication request from another apparatus, and performing an authentication process between an information processing apparatus and the another apparatus in response to the authentication request; and
generating, when the authentication process is performed between the information processing apparatus and the another apparatus, information for notifying a result of the authentication process and information for limiting use of the another apparatus.

14. A non-transitory computer-readable recording medium having a program recorded thereon, the program causing a computer to execute:
obtaining an authentication request from another apparatus, and performing an authentication process between an information processing apparatus and the another apparatus in response to the authentication request; and
generating, when the authentication process is performed between the information processing apparatus and the another apparatus, information for notifying a result of the authentication process and information for limiting use of the another apparatus.
